(19) United States
(12) Patent Application Publication
(10) Pub. No.: US 2007/0106484 A1
(43) Pub. Date: May 10, 2007

(54) Entertainment ride experience enhancement system

(75) Inventors: Phillip J. Sweatman, Vienna, VA (US); Jonathan B. Haller, Round Hill, VA (US)

Correspondence Address: Gibb & Rahman, LLC, 2568-A RIVA ROAD SUITE 304, ANNAPOLIS, MD, 21401, US

(73) Assignee: Triverity Corporation

(21) Appl. No.: 11/268,278

(22) Filed: Nov. 4, 2005

(51) Int. Cl. G05D 1/00; G08G 1/00; G06F 11/00

(52) U.S. Cl. 702/188; 701/1; 701/117

(57) ABSTRACT

An automated entertainment ride experience enhancement system providing a multi-media memento of rides taken for entertainment. The system comprises a series of audio, video and vehicular and personal data capture devices arranged on, adjacent to and remote from the rider transport mechanism of the ride. The system collects and synchronizes audio, video and sensory data streams received from said capture devices which collectively comprise the experience of riders on the ride. The system then encodes, renders and encapsulates said streams into a composite presentation. Said presentation includes selected audio, video and sensor data, said sensor data being presented in either digital or graphic formats and includes menu-accessible ancillary data which is not part of the primary presentation. The composite experience is presented to potential purchasers of recordings of said experience. Said recordings are transferred to commonly used playback mediums for self-serve dissemination to said purchasers.

### RELATED APPLICATIONS

This application is related to U.S. Applications No. 10/278,132 filed Oct. 22, 2002 and 10/278,139 filed Oct. 22, 2002, both now pending.

### FIELD OF THE INVENTION

The present invention relates to the field of entertaining ride enhancements. More specifically, the present invention is an automated, configurable, self-serve experience enhancement system providing a multi-media re-playable memento of rides taken for entertaining thrill or amusement.

### BACKGROUND OF THE INVENTION

Thematic rides taken for entertainment have long captured the attention of people desiring to experience the enjoyment or excitement of being in an amusing or thrilling environment. Theme parks have become a popular destination for vacationers and day trippers, with the nature of many rides at these parks progressing further and further toward the extreme of escape, altered environments or simulated danger. Would-be riders wait in long lines to take a relatively quick trip on such rides and emerge at the end attempting to relive them with loudly verbalized recollections, shouted in excited tones to those who will listen. It is obvious that these riders tend to be enthralled with their experiences and are compelled to perpetuate them through sharing them with others.

To date, only a minor attempt has been made to help capture the experience in some form for later review by these excitable riders. The most commonly used method involves the placing of a camera near a particularly noteworthy aspect of the ride and snapping a still picture as the riders' vehicle passes by. The picture is then displayed as the rider leaves the ride and a copy of the photo is made available for the rider to buy, should he or she so desire. This has proved itself to be a much demanded approach to capture at least one aspect of the experience as a memento for the rider to review and share with friends.

However, this method of experience capture leaves much to be desired. While it does tend to capture a bodily expression of a key moment in time on the ride, it does not do so in a manner which encapsulates the totality of the ride. For example, it does not include any motion or sound and there is nothing to indicate the variety of physical characteristics pertaining to the performance of the ride or corresponding reactions of the rider.

What is needed then is a more comprehensive approach to capturing the essence of an entertainment ride, in a manner that enlists all of the available technologies for doing so and provides a method of reliving the experience in as realistic and individualized a manner as is possible.

### SUMMARY OF THE INVENTION

An entertainment ride experience enhancement system is disclosed which records, stores and offers for playback a rider's experience of participating in an entertaining ride. The experience is captured in a form that may be viewed in real time or reviewed later by the rider and/or others. The system captures recordable aspects of the rider's participation, including visual and audible aspects, the ride vehicle's positional, operational and performance information and bio-physical reactions of the rider to the excitement of the ride. The system then processes and fuses the captured raw data into suitable renderings and encapsulations of the data for recording, which, when played on a suitable playback system, provides the rider with a re-playable memento of the experience. The memento includes rider-perspective and rider-focused visual and auditory recordings synchronized with statistics and metrics of the ride.

In a first embodiment of the invention, the entertainment ride comprises a roller coaster or similar track-mounted or guided vehicular ride, which gives a rider of said vehicle a highly stimulating, thrill-type experience. In this embodiment, the rider is one of a group of riders within the same vehicle or vehicle section who will be a point of focus for the inventive concept.

The inventive system collects, processes and records for later review information related to the rider's experience, including the stimulation of the ride and the rider's responses to it. The stimulation may come in the form of 1) rapid and significant variations in vehicular height, speed, direction and/or orientation which occur and the corresponding forces felt by a rider throughout the ride, 2) corresponding dramatic visual and audible perceptions which tend to accompany such rapid and significant vehicular variations and 3) normal biological human reactions which stem from the combination of such variations and perceptions, such as anticipation, excitement, apprehension and fear. Responses come in the form of 1) nervous chatter, excited outcries, screaming and facial expressions, 2) bodily attempts to either resist or yield to the effects of tri-axial accelerations (G-forces) experienced during the ride, and 3) heart rate and blood pressure changes which tend to accompany any thrilling experience.

In this embodiment, the enhancement system comprises a set of operatively linked equipment components including video cameras and microphones, velocity indicators and position locating devices, and pulse and other biological monitors. Collectively, these components first synchronously capture the stimulations and responses which are associated with a rider's experience on the ride and then process and record those details on associated processing and storage devices controlled by a monitoring and control system. Ultimately, the rider is provided with a copy of the processed and recorded data for later review on the rider's own player. In this way the rider may save and replay the experience of the recorded ride.

The invention's video cameras are located in several locations, positioned so as to capture 1) macro views (far-away views of large portions of the ride, able to capture the vehicle in motion), 2) track-side views, (capturing closeups of the vehicle, approaching or leaving various points around the track and, for instance, while in a horizontal spiral or vertical loop), 3) sets of common riders' views (taken from the perspective of both a rider at the front and a rider at the rear of the vehicle) and 4) views of the group of riders (shots of all or a subset of any group of riders on the ride, including close-up shots of individual riders).

System microphones are located so as to be able to capture an individual rider's audible comments as well as the general background sounds created by both the operation of the ride and its group of riders. The individual microphones may be mounted on the vehicle in close proximity to the targeted rider's position while riding and general noise microphones may be installed with the video cameras which provide macro or track-side views.

Velocity indicators may either be operatively associated with the moving vehicle (as a speedometer) or may be comprised of a set of sensors mounted along the track which pick up signals from emitters mounted on the vehicle.

Position locating devices may comprise a GPS positioning system with a GPS processor mounted on the vehicle, or they may be operatively linked to the velocity sensors (which double as location sensors) placed along the track. Said sensors may comprise infrared, magnetic, RFID, MESH, MOTE or other suitable types of systems.

Pulse and other bio-data sensors may be placed upon the rider's body, utilizing disposable attachment apparatus, and the sensors may be plugged into tamper-proof boxes located within the vehicle. The tamper-proof box contains the interface for collecting and forwarding the readings, which will be combined with the other experience-related data collected by the encapsulation system.

The aforementioned equipment captures and forwards its experience-related data to the processing and storage devices. In this embodiment, the process and storage devices are located on the vehicle or along the track, and the monitoring and control equipment are located within a station associated with the ride. The vehicle and track-mounted equipment is designed to transmit its information in real time to the facility via wireless connections. Alternatively, the information may be transmitted by any other suitable means from the collection equipment to the monitoring and control equipment.

The process devices perform the services of:

1) receiving the transmitted raw audio, video and vehicle and rider sensor data from the vehicle and track-mounted equipment and synchronizing that data within a ride-related time interval,

2) calculating aspects of the ride which may be calculated from the raw data (e.g., speed or G-forces),

3) rendering certain sensor data into a graphical format to provide an animated display during playback (e.g., a digital view of a speedometer or a graphical representation of the position of the vehicle on the track),

4) encapsulating selected raw, calculated and rendered data into a combined version for display, recording and playback,

5) converting the data into a format (e.g., suitable for DVD, mini-DVD, CD-ROM or VHS) that is generally readable by one or a variety of playback devices (e.g., DVD players attached to TVs, PCs including playback application software required, hand-held DVD players, etc.),

6) forwarding the synchronized and rendered data to the monitoring and control system for review by riders and possibly others, and

7) forwarding the converted data to a storage device, from which copies of the individual rider's or group of riders' experience may be made.

Embodiments configuring the system such that at least some of the processing and storage operations are performed at the station are also included.

Other potential embodiments include: 3-D encapsulations of the experience, coded internet access to the recorded experience and 360-degree visual capture for replay with surround-sound via virtual-experience system. Embodiments not depicted herein but which generally rely on the inventive concept are understood to be included in the scope of the invention.

Other potential applications include: 1) being shot out of a cannon, 2) parachute jumping, 3) bungee jumping, 4) space shuttle rides, 5) surfing, skiing and snow boarding, 6) motocross, 7) air boat rides, 8) hot air balloon rides, 9) helicopter rides, 10) hang gliding, 11) sports boat rides, 12) water rides and 13) snowmobile races. Additional applications may also be envisioned without departing from the nature of the inventive concept.

### BRIEF DESCRIPTION OF THE DRAWINGS

Exemplary embodiments of the invention are discussed hereinafter in reference to the drawings, in which:

FIG. 1 is a depiction of a roller coaster comprising the first exemplary embodiment of the invention.

FIG. 2 is a schematic of the arrangement of the cars of the roller coaster of the first embodiment.

FIG. 3 is a schematic of the station of the roller coaster of the first embodiment of the invention.

FIG. 4 is a schematic arrangement of the on-vehicle apparatus of the first embodiment of the invention, depicted on the cars of the roller coaster.

FIG. 5 is a schematic arrangement of the track-side and remote location apparatus of the first embodiment of the invention, depicted relative to the track of the roller coaster.

FIG. 6 is a schematic of the on-board controller of the first embodiment of the present invention.

FIG. 7 is a schematic of the power recharging system of the first embodiment of the invention.

FIG. 8 is a schematic of the kiosk of the present invention.

### DETAILED DESCRIPTION OF PREFERRED EXEMPLARY EMBODIMENTS

The entertainment ride experience enhancement system of the present invention comprises an apparatus and method for collecting and processing for recording and playback certain rider-oriented visual, audible, physical and biological experiences associated with an entertaining ride attraction.

Embodiments hereinafter described are provided as a means to depict the useful nature of the invention, which as one skilled in the art will appreciate, may deviate in application without departing from the scope of the invention.

The Apparatus

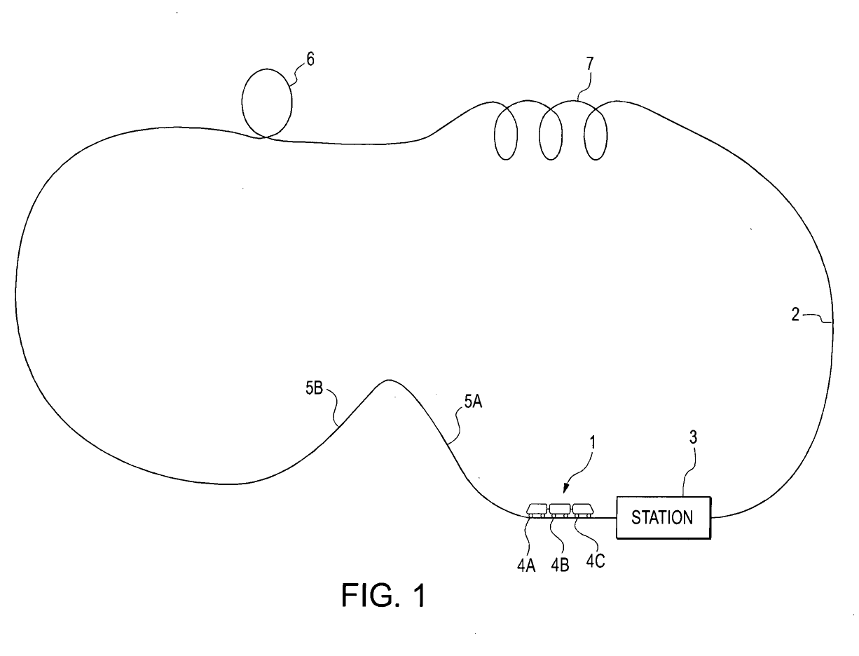

As illustrated in FIG. 1, in a first embodiment of the invention, the entertainment ride comprises a roller coaster 1 associated with a track 2 and a station 3. The roller coaster, track and station are all operatively equipped with apparatus as described hereunder which, when utilized in the method also described enhance the standard amusement park ride by providing a reproducible encapsulation of the experience.

The roller coaster of the first embodiment comprises a set of three cars: a front car 4A, a middle car 4B, and a rear car 4C, each of known design and all physically interconnected so as to be able to travel together as is commonly known in the art. The track of this embodiment is configured with an incline 5A and a decline 5B, a loop 6 and a spiral 7, again, all of types common in the art. As one skilled in the art would recognize, roller coasters comprising more or less cars and track environments with more or less of similar or different thematic features, such as a simulated mountain, a water pond, a tunnel and the like, may characterize alternate embodiments of the inventive concept without departing therefrom.

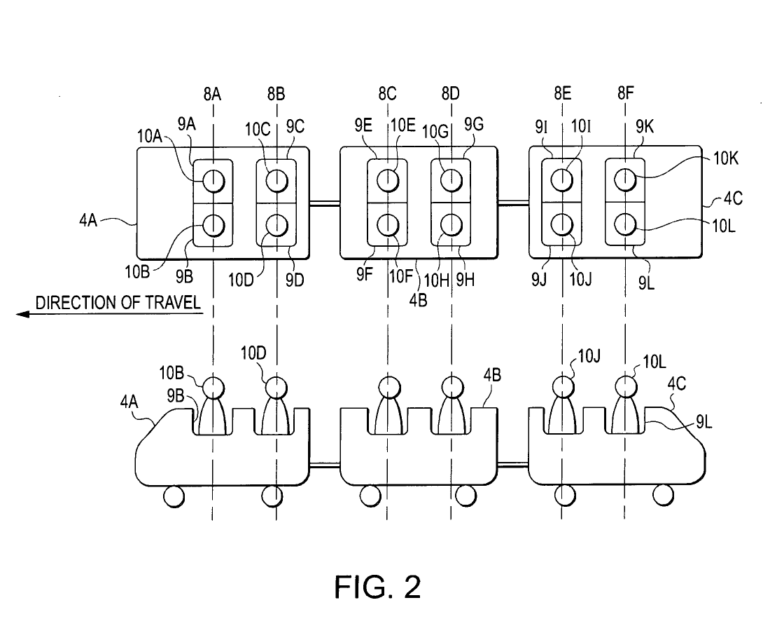

As shown in FIG. 2, each car has two rows of seats for a total of six rows 8A through 8F of two seats for a total of twelve seats 9A through 9L. Each seat potentially holds one rider for a total of twelve riders 10A through 10L. Alternate embodiments may include any number of seats, rows and riders, in any combination, without departing from the nature of the invention.

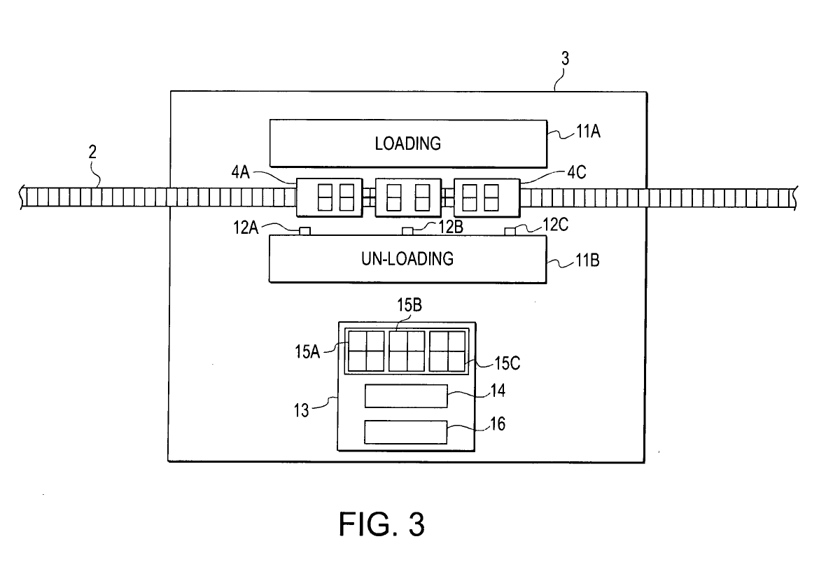

As shown in FIG. 3, the station 3 comprises a loading platform 11A, an unloading platform 11B, a series of power docks 12A through 12C, one associated with each car, and a kiosk 13 comprising a system server 14, a set of previewing monitors 15A through 15C, one associated with each car, and a recording and dispensing device 16.

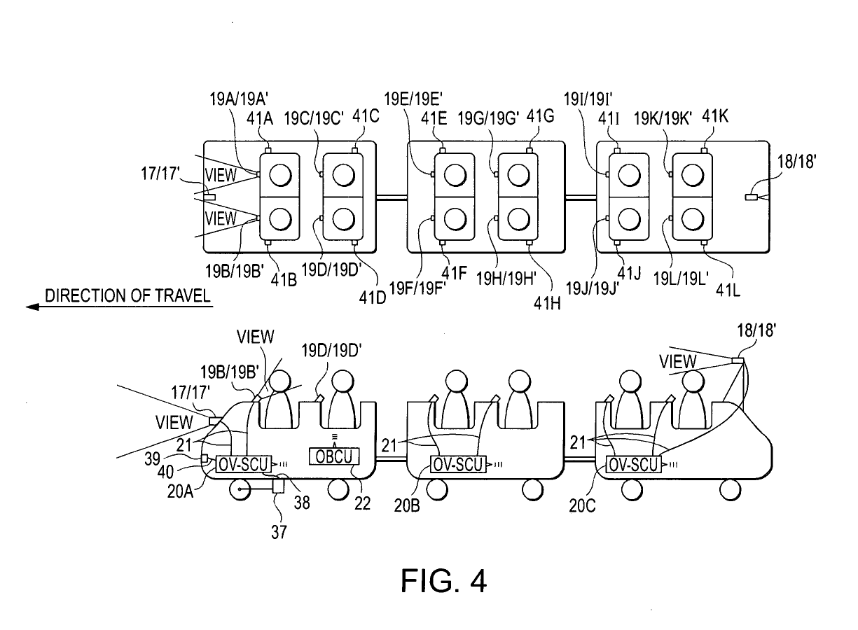

As shown in FIG. 4, each of cars 4A-C is fitted with on-vehicle video and audio collection equipment, positioned so as to capture a variety of views and sounds associated with a given rider's experience while on the ride. In this embodiment, front car 4A is fitted with a front view camera 17, rear car 4C is fitted with a rear view camera 18 and all three cars are fitted with a series of individual view cameras 19A through 19L, one associated with each seat 9A-L. As an alternative, individual view cameras may be associated with more than one seat or other potential rider location. The video cameras may be of any type suitable for the application and may be employed in mixed types. For example, the individual cameras may be relatively lower technology web cameras while the front view camera may be of a higher quality variety. The individual view cameras may have either standard lenses or fish-eye lenses for obtaining wider angle, close-up group or individual shots. Microphones 17′, 18′ and 19A′ through 19L′ (not separately shown) are associated with each respective video camera and may operate coincident with the operation of that camera as is common in the field for audio/video systems. Lighting, such as LED lighting (not shown) may be associated with the individual view cameras such that rider's faces and bodies are illuminated during nighttime rides or dark areas of rides (such as tunnels). In addition to the front and rear view cameras, side and vertical view cameras (not shown) may be associated with the cars. In this way, additional parts of the visual experience, including vertical views at points of rider inversion (as during traversal of a loop or a spiral) may be captured.

The camera(s) and microphones mounted on each car are operatively associated with respective on-vehicle system control units (OV-SCU) 20A through 20C, one OV-SCU for each car. For example, front and individual cameras and their associated microphones are associated with the front car's OV-SCU. All of the cameras and microphones are operatively associated with their respective SCUs via a first set of operative associations 21. Said first operative associations are achieved via a wired transmission connection.

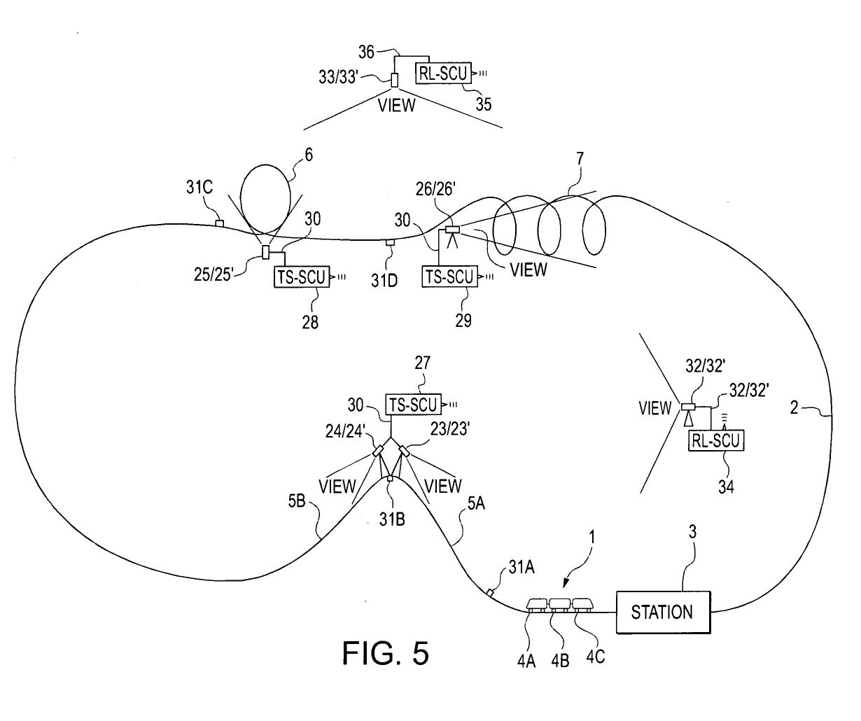

In addition to the above on-vehicle video and audio devices, the inventive device also includes track-side video and audio devices. As shown in FIG. 5, these devices are mounted along the side of the track, particularly in association with any thematic features, so as to capture sights and sounds of cars approaching or leaving said device locations. In this embodiment, there is an incline camera 23 mounted at the top of the incline, positioned so as to be able to view the roller coaster climbing the incline, a decline camera 24 mounted at the top of the decline, positioned so as to be able to view the roller coaster descending the decline, a loop camera 25, positioned so as to be able to view the roller coaster engaging the loop and a spiral camera 26, positioned so as to be able to view the roller coaster engaging the spiral. Similar to the on-vehicle cameras, track-side microphones 23′, 24′, 25′ and 26′ are associated with each respective video camera. Track-side system control units 27, 28 and 29 (TS-SCU) are operatively associated with each of said track-side cameras and microphones via a second set of operative associations 30. Said second set of operative associations are achieved via a wired transmission connection.

The above track-side cameras and microphones are controlled by track-side switches 31A-D which, as shown in FIG. 5, are associated with the track, located appropriately with respect to said track-side video and audio devices, and which are tripped by the front car as it passes the switch location. The switches may be mechanical, optical or any other variety without departing from the invention. Both the track-side cameras and microphones and their associated switches are ideally located at junctures along the track so as to be able to capture track-side images in sequence such that as the cars pass out of range of one camera they enter the field of view of the next, and so on.

Completing the set of video and audio installations, in addition to the on-vehicle and track-side devices, there are also a set of remote-location cameras and microphones. These units are used for capturing sights and sounds of the roller coaster from a distant perspective as the cars proceed around the track. In this embodiment, the invention further comprises an internal view camera 32, located within the perimeter of the track, and an external view camera 33, positioned outside of the track. Remote-location microphones 32′ and 33′ are also associated with each of the remote-located cameras. Remote-location system control units 34 and 35 (RL-SCU) are operatively associated with each of said remote-location video/audio devices via a third set of operative associations 36. Said third set of operative associations are also achieved via a wired transmission connection.

In addition to said video and audio installations, the invention further comprises a series of vehicle data sensors designed to collect data related to the operating performance of the roller coaster's cars. In this embodiment, a speedometer 37, of a variety known in the field, is operatively connected to an axle on the front car of the roller coaster, as indicated in FIG. 4. The speedometer maintains a fourth operative association 38 via a wired transmission connection with the front car's OV-SCU. Data from the speedometer is fed to the OV-SCU located on that car.

In FIG. 4, a known accelerometer 39 is also associated with the front car. The accelerometer records the effects of the motion of the car in terms of the G-forces felt by its occupants. The accelerometer maintains a fifth operative association 40 via a wired transmission connection with the front car's OV-SCU. Data from the accelerometer is also fed to the OV-SCU located on that car.

Finally, bio-data sensors are fitted to each of the riders 10A-L. Specifically, heart rate monitors and other biometric sensors (not shown) are connected to the riders' body, utilizing known bio-data sensors (not shown), prior to boarding the ride. Then, after the riders are seated, the set of monitors is connected to a set of on-vehicle bio-data collection devices 41A-L, one device associated with each seat for each pair of heart rate monitors and biometric sensors. The bio-data collection devices are respectively operatively associated with the on-vehicle system control units (OV-SCUs) of each car via a sixth set of operative associations (not shown). These associations are also made via a wired transmission connection.

Collectively, the vehicle performance data and biological data comprise sensor data, which may be rendered in various forms for processing use, presentation and accessing for analysis.

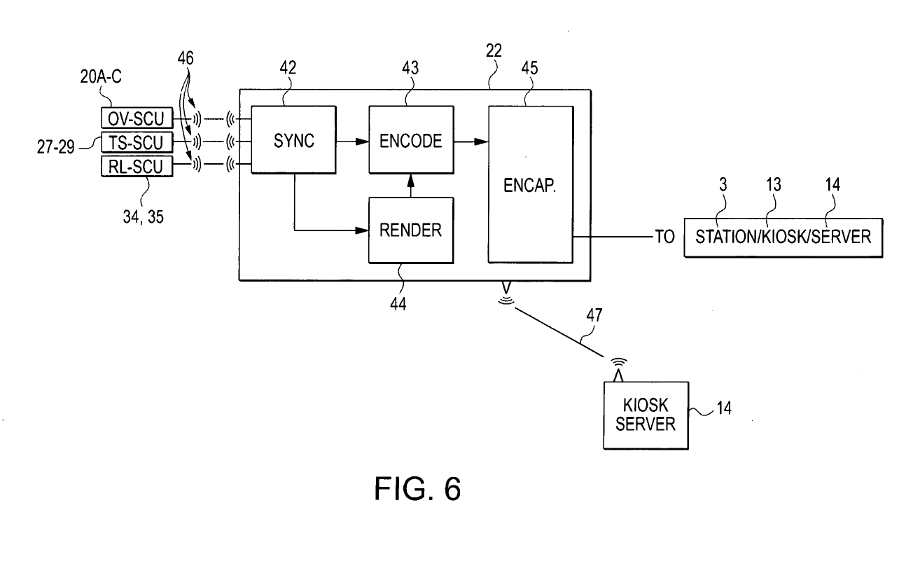

Each of the SCUs (on-vehicle, track-side and remote location variety) is connected to an on-board controller 22 (OBCU), located in the front car (see FIG. 4). As shown in FIG. 6, the on-board controller comprises a synchronization module 42, an encoding module 43, a rendering module 44 and an encapsulation module 45. The synchronization module synchronizes all data streams relative to a start-recording time and location. The encoding module encodes all data streams for a desired playback format, for example, MPEG-2. The rendering module duplicates selected sensor data and converts the duplicated information from digital readouts to various forms of graphical displays. For example, vehicle speed, which is received from the speedometer arrives at the OV-SCU expressed as a mile per hour measurement. The rendering module may convert the mile per hour readout to a graphical readout, for example a circular dial with an indicator arm, or any other format, as is common in the art. The selection of which sensor data to render is programmable and may be changed by a system administrator at the kiosk. The rendered and raw data are both maintained as separate data streams. The encapsulation module receives the synchronized, encoded and selectively rendered data and formats it for display at the previewing monitors. Said formatting includes superimposing the rendered data on top of selected video views.

The three varieties of SCU's are each operatively connected to the on-board controller via a seventh set of operative associations 46. Said seventh set of associations is a wireless connection.

The on-board controller is also connected to the kiosk server at the station via an eighth operative association 47, which also comprises a wireless transmission connection.

At the station, the loading and unloading platforms 11A and 11B comprise industry standard areas for the assembly of riders in an organized manner before getting on the roller coaster and for collecting departing riders upon ride completion. In addition, this embodiment provides for inventive bio-data sensing equipment staging (not shown) prior to its distribution to riders and after its collection from riders. This provision may be in the form of hooks or shelves, and is immaterial to the inventive concept.

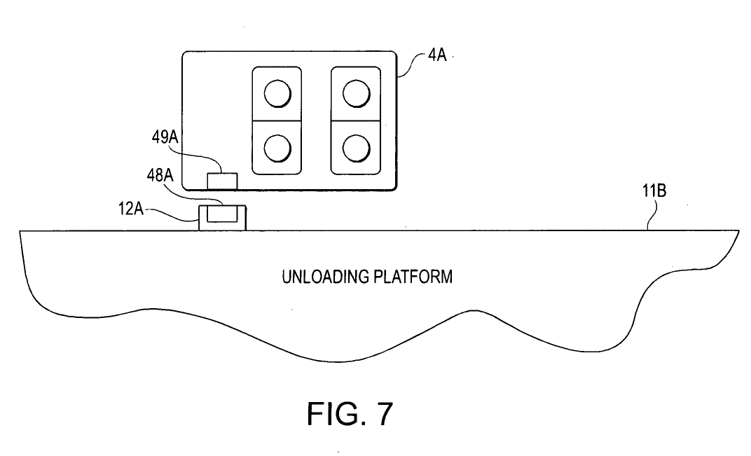

The power docks 12A-C comprise a set of three proximity charging devices 48A-C, one for each car, as part of a known proximity charging system. Said charging system may include batteries, capacitors or other suitable charge storage devices 49A-C operatively associated with said charging devices, one mounted on each car. The proximity charging devices are mounted on the unloading platform, positioned so as to be in close proximity to their associated cars when the cars come to a stop at the completion of a ride for the unloading and loading of riders. This is shown in FIG. 7 for charger 48A and charge storage device 49A. The charge storage devices power the electrically operated equipment (cameras and microphones, OV-SCUs, on-board controller, lights, if any, and the like) which are directly associated with each car. They are positioned on the cars so as to be in close proximity to the charging devices during the loading and unloading periods. As an alternative to said proximity charging system, a slidable-contact point commutator bar arrangement may also be employed for recharging the on-vehicle charge storage devices.

The station may further comprise a depart sensor and a return sensor (neither shown) of any type known in the art, which respectively detect the roller coaster's departure from and return to the station. These sensors respectively may be associated with the on-vehicle recording systems so as to respectively begin and end the recording process.

As stated above, kiosk 13 comprises a system server 14, a set of previewing monitors 15A through 15C, one associated with each car, and a recording and dispensing device 16.

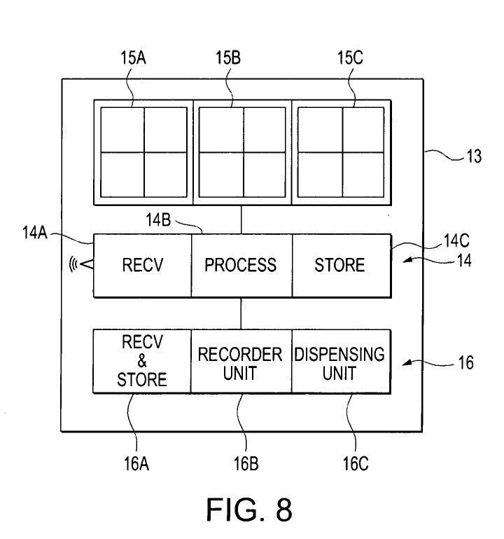

The system server 14 comprises a receiver 14A, a system processor 14B and a data storage device 14C. It is operatively connected to said previewing monitors and also to said recording and dispensing device. The previewing monitors 15A-C may be located in a general viewing area, permitting those waiting in line to board the ride an opportunity to view the experiences of current riders. The monitors may also be located at a rider previewing area as shown in FIG. 8, open only to those departing from a completed ride as is commonly known in the art for still pictures. The monitors may also be located at both types of locations. The three monitors 15A-C are shown with a quadri-split screen, enabling one display per seat of each monitor's associated car. The recording and dispensing device 16 comprises a receiving and storage unit 16A, used as a temporary data buffer, a recorder unit 16B for recording stored data to a variety of selectable playback mediums and a dispensing unit 16C for dispensing said playback mediums to riders wishing to receive, and pay for, such mediums. The playback mediums are designated as VHS, DVD, Mini-DVD and CD, but said designations may vary with operator choice or developing technologies without departing from the scope of the invention.

The Method

Generally, the inventive apparatus performs the functions of: 1) collecting ride-related experience data in the form of raw video, audio, vehicle performance and rider biological data, some of which is relevant to only an individual rider and some of which is common to any and all riders, 2) associating and synchronizing the raw data with the elapsed time of the ride, 3) organizing the data into rider-specific compilations of applicable individual and common data, 4) encoding, rendering and encapsulating the data into presentable visual, audible and graphical representations, 5) presenting the encapsulated data for preview by the riders at the end of the ride, 6) recording the encapsulated data onto rider-selected playback medium, and 7) dispensing the playback medium to the rider.

Specifically, in the above embodiment, as indicated in FIG. 4 (“view”) the front view video camera 17 collects forward-looking, front-perspective images from the front of the front car from the perspective of any rider looking forward in the direction of travel of the roller coaster. The rear view camera 18 collects forward looking, rear-perspective images from the rear of the rear car from the perspective of behind the riders looking forward in the direction of travel of the roller coaster. These two sets of images are common to all riders. Each individual view camera 19A-L records individual images of each respective rider capturing frontal, upper body motions and facial expressions of those riders as the ride progresses. These images are specific to only the targeted individual rider. Side view and vertical view cameras, if present, would collect respectively associated orientation images, including images oriented perpendicular to the top of the roller coaster during periods of inversion of the vehicle. Microphones associated with each video camera record sounds associated with each video view. These sounds include: front vehicle sounds, rear vehicle sounds and individual rider sounds.

The track side video cameras 23, 24, 25 and 26 record incline images, decline images, loop images and spiral images. Each of these images captures a view of the roller coaster as it traverses the respectively associated incline, decline, loop and spiral (see FIG. 5). The microphones associated with these cameras record incline sounds, decline sounds, loop sounds and spiral sounds, each of which are sounds associated with the passing of the roller coaster as it passes thorough the field of view of the respective cameras. These sights and sounds of the ride are common to all riders.

Also as shown in FIG. 5, the remote-location cameras and microphones (32, 33, 32′ and 33′) capture sights and sounds of the roller coaster from a distance as it travels the track. The internal view camera 32 is ideally positioned so as to be able to see a majority of the track from a single location inside its perimeter. This camera captures internal distant views of the roller coaster as it traverses the track. The external view camera 33 is ideally positioned so as to be able to see a majority of the track, also from a single location, but from outside its perimeter. This camera captures external distant views of the roller coaster as it traverses the track. Again, the microphones associated with the remote-location cameras record respective internal distant sounds and external distant sounds associated with said distant views. These views and sounds are all common to all riders.

The above video images and sound recordings are each associated with the elapsed time of the ride during their recording process. This elapsed time association is established as explained below for synchronization purposes later on in the process.

The known speedometer 37 records the number of revolutions of the wheels of the front car in relation to the elapsed time from the start of the ride. Known processes within the OBCU 22 calculate continuous variations on the incremental distance traveled, in association with said elapsed time, and the instantaneous speed of the vehicle relative to points along the elapsed timeline as the ride progresses. Additional known processes calculate the cumulative distance traveled, and from known geometric configurations of the track, they calculate the car's true position on the track, its vertical position and its associated pitch and roll orientations. This vehicle data is common to all riders. The track-side switches 31A-C or similar known position sensing devices may also be used to determine positions and to correct for any calculation error with respect to the distance related calculations noted above.

The known accelerometer 39 (see FIG. 4) is located on the front car. The accelerometer continuously calculates the effective tri-axial G-forces associated with the motion of the vehicle in relation to points along the elapsed timeline of the ride. This data is also common to all riders.

The heart rate monitors and other biometric sensors (not shown) respectively measure the individual rider's heart rate and other biological statistics in association with points along the elapsed timeline of the ride. These are both individual rider's data.

The SCU's perform the function of receiving, timestamping for synchronization purposes and buffering all data received from their associated video cameras, microphones, vehicle motion sensors and rider bio-data monitors. For example, in this embodiment, the OV-SCU in the front car OV-SCU 20A receives input signals from the common front camera 17, each of the four individual cameras 19A-D, each of the four individual microphones 19A′-D′, the speedometer 37, the accelerometer 39, and each of the four heart rate monitors and four other biometric sensors via the four individual bio-data collection devices 41A-D. Each signal has been associated with the elapsed time of the ride as described above. The start of elapsed time for a given ride is established by the on-board controller and disseminated, through its wireless connections, to all referenced SCUs. The SCUs, in turn timecode their audio, video, vehicular and biological data signals as they are received from their respective audio, video, vehicular performance and biological sensing devices.

The timecoded information is transmitted from the SCUs to the on-board controller, where it is again buffered, sorted by timecode and synchronized by synchronization module 42. The synchronized data is then processed by the encoding and rendering modules, as follows. All data received from the SCU is encoded by encoding module 43 in a format suitable for viewing on any of today's technologies. For example, the data may be encoded into MPEG2 and MPEG4 data streams, either as PAL or NTSC signals. Data gathered from vehicle performance and biological sensors is encoded as straight numerical (i.e., digital) values. In addition, the vehicular performance and biological (i.e., sensor) data may be first duplicated and then rendered by the rendering module into graphical displays as described above. The rendered data streams are then transmitted to the encoder module and encoded similarly to the audio and video streams to facilitate their eventual encapsulation for playback.

As the ride progresses, the encapsulation module receives the encoded data for encapsulation. Encapsulation comprises separating from all of the audio, video and sensor data streams those encoded streams which have been designated for simultaneous presentation, and encapsulating them into a coherent, compilation of audio, video and either numerical or rendered data. The encapsulated compilation of data may include a plurality of various sized video viewing areas, each area for viewing different synchronized video views, and a sensor data viewing area, all of which are combined onto a single stream of encoded frames. The choice of which streams to encapsulate is pre-programmed within the encapsulation device by a system administrator. This pre-programming process may be accessed through the kiosk server. The setting may comprise both static designations and dynamic designations. Static designations would not change throughout the duration of the ride. For example, the individual view camera may be selected for continuous encapsulation for the duration of the ride. Dynamic designations may be adjusted during the ride based on instantaneous values of the sensor data. For example, an external view camera's video stream previously selected for encapsulation at the start of a given ride may be changed in favor of a spiral camera's video stream based on the cars reaching the specific location on the track corresponding to the beginning of the spiral.

Encapsulation continues throughout the duration of the ride. During this time, the on-board controller continuously transmits the encapsulated data to the kiosk at the station over the eighth operative wireless connection 47. The system server 14 at the kiosk receives and separates the continuous streams of encapsulated data for storage and display. The separation of the data is organized by car, row and seat to facilitate individual rider-focused displays and recordings. The server transmits the organized data for display on the previewing monitors. Where the monitors are in a general viewing area (not shown), the display is viewed in near-real time as it is received at the kiosk and first processed for display by the system. Where the monitors are in the rider previewing area (see FIG. 3), the server may delay the transmission of the separated data until the riders have a chance to congregate for viewing the display. The server may also retransmit to these monitors for a predetermined time after the completion of the ride to permit riders ample time to preview the encapsulation of the ride. The server 14 also transmits the separated data to the recording and dispensing device 16 where it is received and stored by the receiving and storage unit 16A until selected by a rider for recording via recorder unit 16B on a selectable playback medium.

The on-board controller 22 also permits non-selected encoded data streams to be forwarded to the encapsulation device. These non-selected streams may be recorded as ancillary data on the selected playback medium, which then may be recalled via the use of ancillary data access menus encoded into the medium. Software for navigating and playing the playback medium may also be provided on the playback medium as is generally known in the art, for example, DVD systems.

The previewing monitors are arranged such that each individual rider's relevant preview (i.e., the encapsulated data separated and organized by seat) is displayed on a separate screen arranged four per monitor according to car, row and seat.

After previewing their relevant previews, the individual rider may opt to take away a copy of the encapsulation as a re-playable keepsake as a way to perpetuate the rider's experience with the ride. To do so, the rider would select a playback medium (e.g., VHS, CD, DVD, Mini-DVD or Internet) from the recording and dispensing device 16, pre-pay for delivery and request that the rider's ride encapsulation be recorded onto said medium. The recording and dispensing device will then transfer the data record to the playback medium and dispense the item to the rider via dispensing unit 16C. It is envisioned that playback devices would include VHS, CD, DVD and Mini-DVD players, laptop computers, PDAs, cellular phones and similar equipment. The entire selecting, paying, recording and dispensing process at the recording and dispensing device may be performed on a self-serve basis. Alternatively, the rider interface at the kiosk may be operator or administrator-assisted.

At the end of the ride, the cars returning to the station will physically align themselves with their respective recharging devices for recharging, with each charge storage device 49A intimately adjacent to each recharging device 48A, as shown in FIG. 7. The charge storage devices may be recharged to ready the cars for another ride.

Throughout the above description of this embodiment, specific arrangements and operations of and interfaces between the disclosed devices have been described. As one skilled in the art will readily appreciate, variations on the implementation and utility of these or alternate devices may be envisioned without departing from the inventive concept of an automated, configurable, self-serve experience encapsulation system providing a multi-media, re-playable memento of rides taken for amusement.

Depictions of encapsulated experiences containing multiple ride-associated camera views and superimposed sensor data can be found in prior art. Specifically, co-pending application Ser. No. 11/017,239 by Robert C. Steele in FIG. 13, which is incorporated herein by reference, depicts a first area containing multiple camera views of a common event, focusing on both an individual rider and on a course of travel traversed by that rider, and superimposing graphically rendered, associated sensor data onto areas surrounding said first area within the same screen.

Alternatives

One alternative to the embodiment presented above comprises having each of the SCUs (on-vehicle, track-side and remote) wirelessly transmit directly to a remote control unit at the station. The control unit may be integrated with the station server or it may be separate from it without departing from the nature of the inventive idea.

Another alternative comprises a non-wireless connection between the control unit on the vehicle and the server at the kiosk. Said connection may be facilitated by a wired, infrared or any other suitable connection which may be made once the cars come to a stop at the unloading platform. For example, the slidable-contact point commutator bar arrangement noted above may be employed in conjunction with its power recharging functionality. In addition, all other operative associations are depicted in the exemplary embodiment as either wired or wireless. With the exception of devices which do not maintain fixed positions relative to each other, any connection depicted in the exemplary embodiment as wireless may also be a configured as a wired connection. Lastly, without exception, any wired connection may also be configured as wireless. Any of these alternatives may be employed without departing from the concept of the invention.

Other alternatives include various options on the graphic displays, for example including a time or distance-based graphical representation of the readouts or a superimposition of one or more types of data on a single time or location-based graph. Additionally, the display may feature a graphic depiction of the track or path of the amusement ride with the associated vehicle's location superimposed by a moving marker on said depiction as the vehicle traverses the track.

In an alternate embodiment, the apparatus for data capture, processing and transmission may be located and configured for more centralized system management. For example, on-vehicle devices which are associated with cameras, microphones and vehicular performance and bio-data sensors located on the moving roller coaster (or any other type of entertaining, thrilling or educational ride) may only capture and store the received associated raw data. Upon arrival at the station at the end of the ride, the raw data may be transferred from the roller coaster to a central processing unit, located at a kiosk, through a commutator bar or other communication means. The on-vehicle data collection devices collect and synchronously time code raw video, audio and sensor data based on a synchronous start signal when leaving the station. Track-side data collection devices may optionally collect similar synchronized raw data and transmit same (via either wired or wireless connections) to the central processing unit during or at the end of the ride. Upon receipt of the on-vehicle raw data upon the vehicle's return, the central processing unit at the kiosk would perform the operations of receiving, separating and organizing the data by rider (or other basis), encoding, rendering and encapsulating the organized data for preview by targeted users, and, optionally, upon suitable authorization (i.e., payment for same or some other authorizing action), placing the encapsulated data onto a medium of the user's choice for delivery as described above. The centralized processing system, which may be either automated or administrator-operated, may optionally delay all or part of the processing (e.g., encoding, rendering and/or encapsulating) until a rider elects to receive a recording of the experience. For example, still-photos taken from raw video images may be first posted to a preview screen. At the request of a rider, an encoded version of the associated raw video may be presented to the rider for preview. Upon further authorization, a fully rendered and encapsulated rendition of the experience may be created, based on the rider's designated formatting/medium preferences, and delivered on the medium to the rider.

In an optional feature, the inventive system may integrate thematic elements associated with the ride into the rendering and encapsulation. For example, thematic logos, backgrounds and music or other sounds may be incorporated into the final presentation to the riders. Also, superimposition of graphical effects may be employed. For example, an animated thematic character (e.g., Scooby Doo) may be superimposed over an image associated with an empty or occupied seat near a rider to create the illusion of the rider riding with such character when the recording is replayed.

In another optional feature, electronic clips containing all or parts of the recorded experience may be e-mailed to recipients designated by a rider, including the rider himself. The inventive system may include internal intelligence for the purposes of automatically selecting a particularly exciting portion of the ride to be sent, for example, 30 seconds of a downhill run. The selection intelligence may be based on sensor data parameters, such as track position or vertical height, all of which are synchronized with the data in the clip to be sent. Again, dispatching of the electronic clip may be arranged on a self-serve or semi-automated basis upon receipt of payment for the service.

Also, the raw, synchronized and encoded audio, video and combined sensor data may be used as inputs to a ride simulator, allowing a user to recreate the ride experience in a closed system, similar to those common in the art for simulated rides. In this manner, riders participating on different rides may each be able to recreate their respective experience within a common simulator.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

What is claimed is:

1. A method of enhancing an experience of a motional event, comprising:
collecting tri-media data related to said motional event, wherein:
said tri-media data comprises separable and at least one-dimensionally synchronized audio, video and sensor data associated with a user's experience with said motional event, wherein;
said sensor data comprises:
motional data related to a conveyance means associated with said user during said motional event;
encoding, rendering and encapsulating said tri-media data for presentation and analysis, creating encapsulated tri-media data;
presenting said encapsulated tri-media data for viewing;
storing said encapsulated tri-media data in association with a dispensable medium for playback on a playback means; and
dispensing said encapsulated data via said dispensable medium.

2. The method of claim 1, further comprising the step of:
playing back said encapsulated tri-media data received via said dispensable medium via said playback means in the presence of at least one viewing party.

3. The method of claim 1 wherein said motional event is a ride on a roller coaster.

4. The method of claim 1 wherein said collecting comprises selecting for receipt portions of said one-dimensional, synchronized audio and video data based upon at least one instantaneous value of said sensor data.

5. The method of claim 1 wherein said conveyance means is a car on a roller coaster.

6. The method of claim 1 wherein said motional data is selected from the group comprising temporal position, track position, distance traveled, vertical height, speed, unidirectional G-force acceleration, tri-axial G-force acceleration, pitch orientation, roll orientation and data derived therefrom.

7. The method of claim 1, wherein said sensor data further comprises biological data associated with said user while said user is associated with said conveyance means during said motional event.

8. The method of claim 7 wherein said biological data is selected from the group comprising heart rate, blood pressure, breathing rate, adrenalin production, perspiration production and bodily deformations and displacements.

9. The method of claim 1 wherein said encoding comprises formatting said tri-media data into separable encoded streams of audio, video, motional and biological data comprising encoded data.

10. The method of claim 1, wherein said rendering comprises duplicating and representing at least parts of said sensor data into graphic representations of sensor data and then encoding said graphic representations of sensor data into rendered data.

11. The method of claim 1, wherein said encapsulating comprises compiling said encoded and rendered data into configurable, presentable and analyzable streams.

12. The method of claim 1, wherein said presenting comprises displaying said encapsulated tri-media data on monitors viewable in real time.

13. The method of claim 1, wherein said presenting comprises displaying said encapsulated tri-media data on monitors viewable by at least one viewing party subsequent to said motional event.

14. The method of claim 1, wherein said dispensable medium is selected from the group comprising a CD disc, a DVD disc, a Mini-DVD disc, a VHS tape and the Internet.

15. The method of claim 1, wherein said dispensing comprises delivering said dispensable medium from a self-serve kiosk subsequent to purchase of said dispensable medium.

16. The method of claim 1, wherein said playback means comprises one of a CD player, a DVD player, a mini-DVD player, a VHS player, an Internet delivery service and a motional event simulator.

17. The method of claim 1, wherein said encoding, rendering and encapsulating may be performed, at least in part, on devices physically associated with said conveyance means.

18. The method of claim 1, wherein said encoding rendering and encapsulating may be performed, at least in part, on devices not physically associated with said conveyance means.
